(19) United States
(12) Patent Application Publication
(10) Pub. No.: US 2020/0350797 A1
(43) Pub. Date: Nov. 5, 2020

(54) GEOMETRY FOR SINGLE-LAYER WOUND STATORS WITH HIGH MANUFACTURABILITY

(71) Applicant: Lin Engineering, Inc., Morgan Hill, CA (US)

(72) Inventors: Nicholas A. Vergara, Campbell, CA (US); Harlan H. Nguyen, San Jose, CA (US); Hoang Le, San Jose, CA (US)

(73) Assignee: Lin Engineering, Inc., Morgan Hill, CA (US)

(21) Appl. No.: 16/820,442

(22) Filed: Mar. 16, 2020

Related U.S. Application Data
(60) Provisional application No. 62/842,719, filed on May 3, 2019.

(51) Int. Cl. H02K 3/28

(52) U.S. Cl. CPC H02K 3/28

(57) ABSTRACT

An electric motor comprises a stator and a rotor having a specified number of rotor poles that magnetically interact with the stator so as to rotate in relation to the stator. The stator is a slotted stator with a specified number of stator poles with slots between those poles and is provided with a set of conductive windings that are fitted into the slots and wound around the stator poles according to a specified pattern. The motor has a single-layer winding configuration, wherein there are one or more empty stator poles without windings on each side adjacent to those stator poles with a winding, so that only one set of windings is present in each slot. Stator poles with a winding terminate in a stator shoe, while stator shoes are absent from each empty stator pole, thereby expanding the gap for machine winding into the slots.

### CROSS-REFERENCE TO RELATED APPLICATION

The present invention claims priority under 35 U.S.C. 119(e) from prior U.S. provisional application 62/842,719, filed May 3, 2019.

### TECHNICAL FIELD

The present invention relates to electric motors (dynamo-electric machines) with particular attention to details of the stator structure and its windings, formed by laying conductors into and around core parts, such as slotted stators, to facilitate automated manufacturing with ever larger numbers of stator slots.

### BACKGROUND ART

Recently, the manufacturing of 3-phase brushless DC motors with a high number of stator slots is a challenge to automation in the fractional-horsepower (<746 W output) electric motor industry.

The number of stator slots and rotor poles used is a fundamental design decision influencing the size of the motor. For any motor design, configurations with a higher number of slots allows for designs with thin back iron sections, leading to highly desirable designs with large inner diameters and minimized overall mass. However, as the number of slots increases for a given motor diameter, the minimum spacing between slots decreases, preventing winding needles from passing through for machine winding.

Common stator slot/rotor pole combinations used in this industry are:

6 stator slots with 8 rotor poles;

9 stator slots with 6 rotor poles;

9 stator slots with 12 rotor poles;

12 stator slots with 8 rotor poles;

12 stator slots with 10 rotor poles;

12 stator slots with 14 rotor poles;

24 stator slots with 20 rotor poles; and

36 stator slots with 30 rotor poles,

where there are windings present on every stator slot, having two coils sides per slot. This winding configuration is commonly referred to as a double-layer winding.

In three-phase motors, windings associated with each drive phase A, B, and C are wound in the successive stator slots according to some specified pattern, such as ABC ABC ABC, or Aa bB Cc aA Bb cC (where the lowercase indicates a reverse winding direction), and then are connected together in an overall circuit in either a delta (parallel) or wye (series) connection to receive the energizing drive current pulses in a specified sequence. A delta connection tends to achieve higher top speeds but with lower torque than the wye connection, whereas the wye connection tends to provide higher torque at low speeds.

FIGS. 1A and 1B respectively show an outrunner motor configuration and an inrunner motor configuration. An outrunner motor has its rotor 11 as a shell rotating outside the stator 12. In an inrunner motor, the rotor 13 is located inside the stator 14. Outrunner motors can typically have more poles and produce more torque but tend to spin slower than comparable inrunner motors.

Alternate winding configurations are available, such as a double-layer winding (FIG. 2), and a single-layer winding (FIG. 3) where in the latter case only one coil side is present per slot. However, the single-layer winding is uncommon in fractional-horsepower machines due to taller end winding heights, greater torque ripple, and greater spatial harmonic content. Efforts have been made to study and address such pitfalls, as well as maximize performance through finding an ideal stator shoe and tooth width geometry. The “ideal” geometries found to date, however, have manufacturing limitations preventing practical usage.

U.S. Pat. No. 4,234,808 to Geppert et al. illustrates several configurations in embodiments of homopolar stepping motors having field windings about the stator poles. One embodiment has monofilar windings and shows a typical circuit connection and energization sequence for that monofilar winding configuration. Two other embodiments employ bifilar windings with each pair of partial windings connected either in parallel or in series with each other. That patent also shows that insulation can be fitted into the spaces between the stator poles and axially split at their radially inward portions to define respective wire winding gaps, each not less than 2 mm wide. In all of these cases, whether monofilar or bifilar, all of the stator poles are wound, leading to double-layer winding for all of the slots.

### SUMMARY DISCLOSURE

A motor according to the present invention provides novel slot geometry modifications to the stator to allow for winding automation where previously it was not possible with single-layer winding configurations. The invention covers any motor type using a combination of the required pole winding configuration and stator shoe geometry. Specifically, in the present invention there is at least one empty stator pole on each side adjacent to stator poles with a winding. Each stator pole with a winding terminates in a stator shoe, while stator shoes are absent from each of the empty stator poles. Removing the shoes from the empty stator poles increases the gap size for the slots to allow for automated winding capability in cases where it was previously not possible.

Thus, an electric motor is provided that comprises a stator and rotor, wherein the rotor has a specified number of rotor poles that magnetically interact with the stator to rotate in relation to the stator. The stator is a slotted stator with a specified number of stator poles with slots therebetween. The stator is provided with a set of conductive windings that are fitted into the slots and wound around the stator poles according to a specified pattern. There is at least one empty stator pole adjacent to each stator pole with a winding.

Each stator pole with a winding terminates in a stator shoe, while stator shoes are absent from each empty stator pole. The stator shoes that terminate each wound stator pole extend radially into a corresponding winding gap between the stator poles, thereby narrowing such gaps over the slots. Thus, having shoeless empty stator poles presents a larger gap. Conductive windings have a maximum wire gauge size or diameter for the available winding gap, so the larger gap presented by invention permits a larger wire gauge for the windings than conventional motors that have shoes on every stator pole.

The stator construction of the present invention can be employed for both outrunner and inrunner motor configurations. The present invention removes certain manufacturing limitations to allow stators with single-layer windings in slots to be used.

### BRIEF DESCRIPTION OF THE DRAWINGS

FIGS. 1A and 1B respectively show an outrunner motor configuration and an inrunner motor configuration.

FIG. 2 shows a double-layer winding configuration, where there are two coils sides per stator slot.

FIG. 3 shows a single-layer winding configuration, where only one coil side is present per slot, but also where, in accord with the prior art, all poles are still terminated by shoes.

FIGS. 4A and 4B compare slot gaps for the invention and the conventional design in the prior art, respectively.

FIG. 5 is a more detailed view of the slot geometry for the invention.

FIG. 6 is a more detailed view of the slot geometry for the standard design in the prior art.

FIG. 7 is a closeup of a portion of a wound stator in accord with the present invention with shoeless empty poles in the single-layer winding layout.

### DETAILED DESCRIPTION

For 3-phase brushless DC (BLDC) motors, there are several rotor pole and stator slot combinations that can be used with the present invention:

Number (N) of stator slots/number (P) of rotor poles=0.857,0.937,1.07, or 1.2
Number of stator slots=12,
Number of rotor poles=10 (5 pairs);
Number of stator slots=15,
Number of rotor poles=14 (7 pairs);
Number of stator slots=15,
Number of rotor poles=16 (8 pairs);
Number of stator slots=24,
Number of rotor poles=20 (10 pairs);
Number of stator slots=30,
Number of rotor poles=28 (14 pairs);
Number of stator slots=30,
Number of rotor poles=32 (16 pairs);
Number of stator slots=36,
Number of rotor poles=30 (15 pairs);
Number of stator slots=36,
Number of rotor poles=42 (21 pairs); . . .

Automated machine winding is restricted by the maximum allowable gap for a winding needle to pass through. Too small of a gap will eliminate the possibility of machine winding altogether. Additionally, the larger the available gap, the larger the needle can be used, allowing for larger wire sizes for winding. Table 1 shows typical machine winding capabilities (“AWG” refers to American Wire Gauge, ASTM B258):

TABLE 1

| Min. Slot Gap Required | Maximum Wire Size Acceptable |
|---|---|
| 0.044 inch (1.12 mm) | 34 AWG (0.160 mm diam.) |
| 0.060 inch (1.52 mm) | 28 AWG (0.321 mm diam.) |
| 0.080 inch (2.03 mm) | 24 AWG (0.511 mm diam.) |
| 0.101 inch (2.57 mm) | 19 AWG (0.912 mm diam.) |
| 0.140 inch (3.56 mm) | 15 AWG (1.450 mm diam.) |
| 0.177 inch (4.50 mm) | 13 AWG (1.828 mm diam.) |

Using a single-layer winding configuration or layout in conjunction with the present invention's stator shoe width optimization, i.e. the removal or absence of shoes from empty stator poles, allows minimum gaps of slots between the poles to increase by a factor of approximately 1.5× over a standard slot gap. As always, slot gap sizes scale with the overall motor diameter; so, the present invention also allows smaller motors to be constructed that were previously unachievable. Table 2 shows slot gap metrics for various stator slot and rotor pole configurations.

TABLE 2

| | | Standard Pole Configuration | | Invention Pole Configuration | |
|---|---|---|---|---|---|
| | | Gap | | Gap | |
| | | Available for | | Available for | |
| Motor | Slot/Pole | Winding | Maximum Wire | Winding | Maximum Wire |
| Configuration | Configuration | Needle | Size | Needle | Size |
| Inrunner | 12 Stator | 0.098″ | 19AWG | 0.148″ | 18AWG |
| Stator ID: | Slots, 10 | (2.49 mm) | (0.912 mm diam) | (3.76 mm) | (1.024 mm diam) |
| 1.181″ | Rotor Poles | | | | |
| (30 mm) | | | | | |
| Inrunner | 24 Stator | 0.08″ | 24AWG | 0.115″ | 19AWG |
| Stator ID: | Slots, 20 | (2.03 mm) | (0.511 mm diam) | (2.92 mm) | (0.912 mm diam) |
| 4.25″ | Rotor Poles | | | | |
| (108 mm) | | | | | |
| Outrunner | 36 Stator | 0.11″ | 19AWG | 0.179″ | 13AWG |
| Stator OD: | Slots, 30 | (2.79 mm) | (0.912 mm diam) | (4.55 mm) | (1.828 mm diam) |
| 4.972″ | Rotor Poles | | | | |
| (126.3 mm) | | | | | |

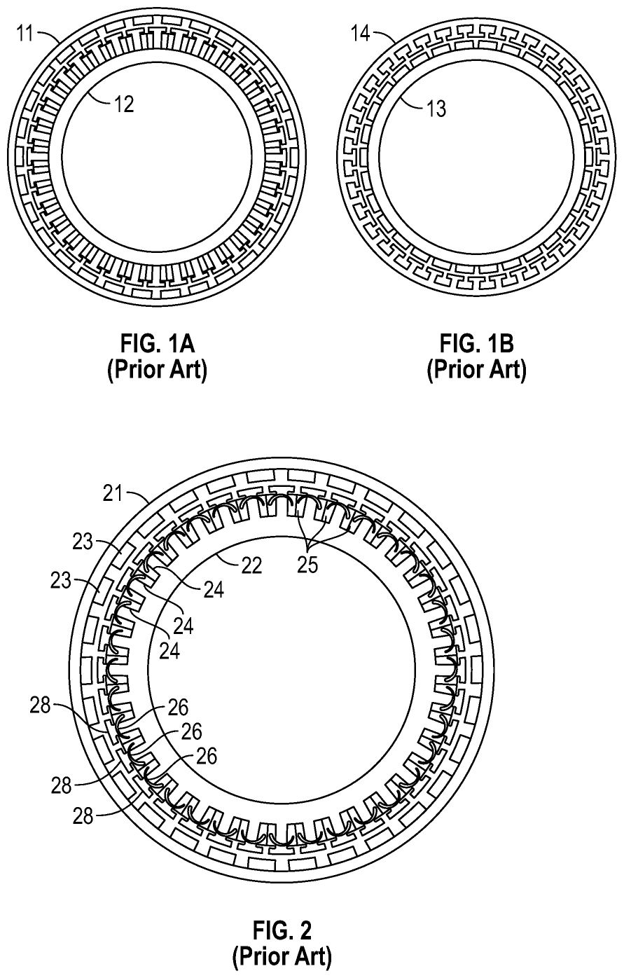

The invention can be applied to any motor type and configuration, including both outrunner and inrunner configurations (see FIGS. 1A and 1B).

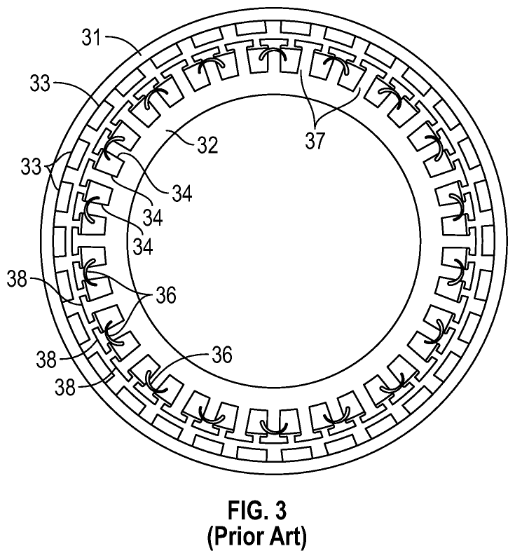

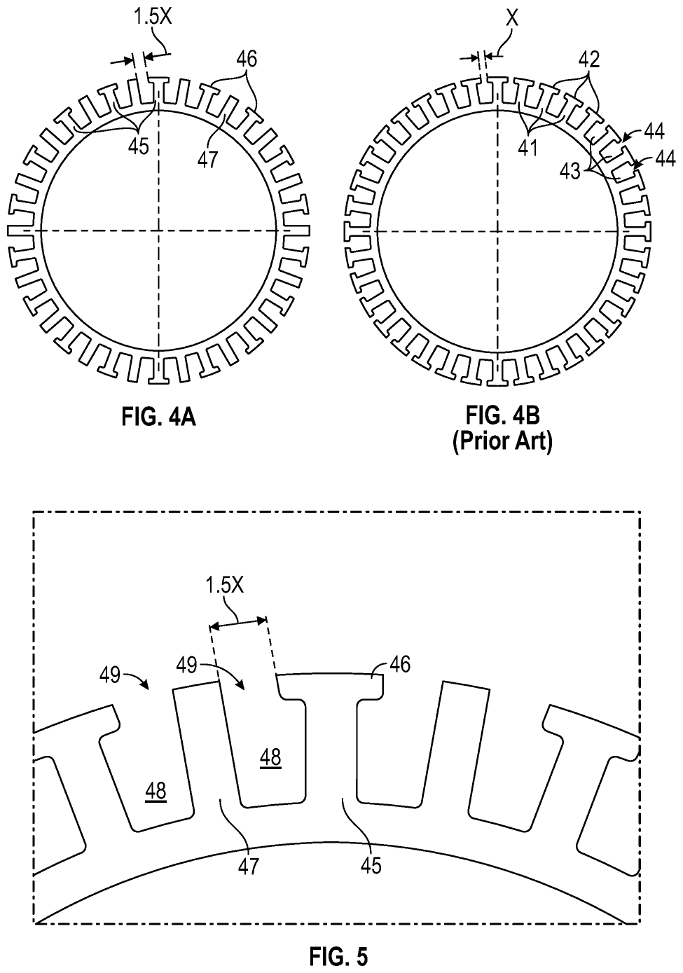

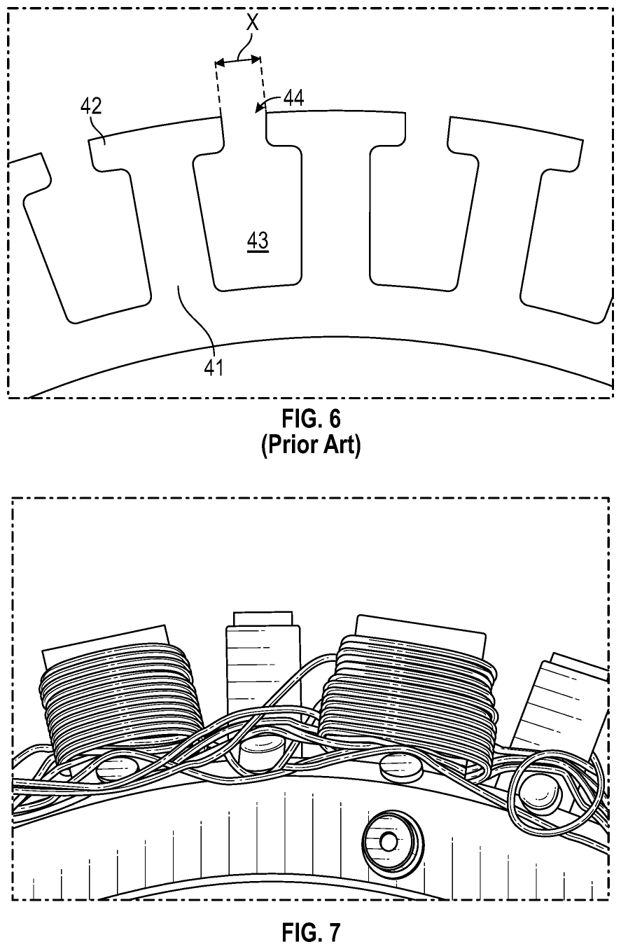

Using an outrunner style BLDC with 36 stator slots and 30 rotor poles as an example:
As seen in FIG. 2, a conventional motor of the prior art has an outer rotor 21 and an inner stator 22. The rotor 21 contains a set of rotor poles 23, here comprised of permanent magnets, arranged radially around the inner circumference of the rotor 21. The successive rotor poles 23 typically alternate in N/S magnetic polarity. The stator 22 contains a set of stator poles 24 arranged radially around the outer circumference of the stator 22 with stator slots 25 between adjacent stator poles 24. Conductive phase windings are inserted within the respective slots 25 and wound around each of the poles 24. The stator poles 24 terminate at their outer ends in stator shoes 28 that extend over the respective slots 25. As seen here, a motor with a conventional double-layer winding configuration would have windings 26 around all stator poles 24 and in all stator slots 25, with uniform stator shoe 28 dimensions on all stator poles 24. The phase windings 26 follow some specified pattern for the three drive phases A, B and C, such as 3×{Aa bB Cc aA Bb cC}, giving the set of windings that might be labeled A1-A12, B1-B12, and C1-C12 within slots that might be numbered 1-36.
As seen in FIG. 3, the present invention requires a single-layer winding layout, where there is at least one empty slot on locations adjacent to each phase winding. However, in FIG. 3 a conventional stator construction is still employed (all stator poles terminate in stator shoes), leading to manufacturing limitations on motor and winding sizes. This outrunner motor has an outer rotor 31 and an inner stator 32. The rotor 31 again contains a set of rotor poles 33, comprised of permanent magnets, arranged radially around the inner circumference of the rotor 31. The successive rotor poles 33 typically alternate in N/S magnetic polarity. The stator 32 contains a set of stator poles 34 arranged radially around the outer circumference of the stator 32 with stator slots 35 between adjacent stator poles 34. Conductive phase windings are inserted within the respective slots 35 and wound around every other stator pole 34. Thus, some stator poles 34, instead of having windings 36, are empty poles 37. All stator poles 34 still terminate at their outer ends in stator shoes 38 that extend over the respective slots 35. Again, phase windings follow some specified pattern for the three drive phases A, B and C, such as 3×{ABC ABC}, giving the set of windings that might be labeled A1-A6, B1-B6, and C1-C6, within slots that might be numbered 1-36.
   FIGS. 4A and 4B compare the invention vs conventional design slot gaps. FIG. 5 is a more detailed view of the slot geometry for the invention, while FIG. 6 is a more detailed view of the slot geometry for the standard design. FIG. 7 shows a closeup of a portion of a stator according to the invention with single-layer windings with empty slots in the winding layout and with shoeless empty stator poles.

As noted for the single-layer BLDC motor of FIG. 3, and as seen more closely in FIGS. 4B and 6, all the stator poles 41 terminate in stator shoes 42 whether they are intended to be wound or not. Shoes 42 extend circumferentially beyond the physical width limits of the poles 41 and thus hang over the slots 43. This narrows the gap 44 to a gap dimension X leading into the stator slots 43 between the adjacent poles 41.

The stator shoe optimization of the present invention requires removal of stator shoes altogether on the empty slots. This is seen in FIGS. 4A and 5. Those stator poles 45 that are intended to be wound with the phase winds terminate in stator shoes 46, but other poles 47 intended to remain empty to not terminate in shoes. The slots 48 between stator poles 45 and 47 thus have an enlarged gap 49 that is substantially wider than the gaps 44 for standard slots 43. For example, the enlarged gap dimension could be 1.5× compared to the standard gap dimension X. One advantage is that the slots 48 themselves can be equal or smaller in width than the standard slots 43 and still provide a usable gap for automated winding. This allows comparably more slots to be used for any given motor size. Alternatively, larger diameter windings could be employed. In either case, overall performance does not significantly reduce compared to a conventional design, such that the magnetic flux density at the shoe is limited to ˜1.5 Tesla.

Empty stator slots (i.e. slots that lack winding) are part of the requirement for this invention's single-layer winding configuration, and those empty slots are where the shoes must be removed. To summarize the requirement:
1. Design must follow the slot/pole formula provided in order to find an eligible winding layout.
2. The shoe removal will be only on the empty poles.
3. The calculated rated flux density at the shoe must be restricted to ˜1.5 Tesla to hit performance claims.

The invention achieves improved winding manufacturability with minimal performance difference compared to a conventional design:
1. The increase in gap size allows for automated winding when capability would not normally be possible.
2. The increase in gap size allows for larger wire sizes to be used in the automated winding process.
3. Winding indexing time is reduced as a consequence of the single-layer winding.

What is claimed is:

1. An electric motor, comprising:
a stator and a rotor having a specified number of rotor poles that magnetically interact with the stator so as to rotate in relation to the stator, the stator being a slotted stator with a specified number of stator poles with slots therebetween, the stator being provided with a set of conductive windings that are fitted into the slots and wound around the stator poles according to a specified pattern;
wherein there is at least one empty stator pole adjacent to each stator pole with a winding, each stator pole with a winding terminating in a stator shoe while stator shoes are absent from each empty stator pole.

2. The motor as in claim 1, wherein the stator shoes terminating each wound stator pole extend radially into a corresponding winding gap between stator poles, narrowing those gaps, while empty stator poles with shoes absent present a larger gap.

3. The motor as in claim 1, wherein the conductive windings have a maximum wire gauge size or diameter for the available winding gap between stator poles.

4. The motor as in claim 1, wherein exactly half of the stator poles are wound with conductive windings while every other pole around the stator is empty.

5. The motor as in claim 1, wherein the stator has a single-layer winding configuration for each slot.

6. The motor as in claim 1, comprising an outrunner motor wherein the rotor is located outside the stator.

7. The motor as in claim 1, comprising an inrunner motor wherein the rotor is located inside the stator.
